(19) United States
(12) Patent Application Publication
(10) Pub. No.: US 2012/0025730 A1
(43) Pub. Date: Feb. 2, 2012

(54) Circuit Arrangement and Method for Operating a High-Pressure Discharge Lamp

(76) Inventor: Herbert Kaestle, Traustein (DE)

(21) Appl. No.: 13/263,321

(22) PCT Filed: Mar. 30, 2010
(86) PCT No.: PCT/EP10/54187

§ 371 Date: Oct. 6, 2011

(30) Foreign Application Priority Data
Apr. 6, 2009 (DE) 10-2009-016579.7

(51) Int. Cl. H05B 41/36

(52) U.S. Cl. 315/224

(57) ABSTRACT

A circuit arrangement for operating a high-pressure discharge lamp (5) having a straightened arc, comprising: at least one first (Q1) and one second electronic switch (Q2) in a first half-bridge (6); a supply voltage connection and a reference ground connection for supplying the half-bridge arrangement with a direct voltage signal (U₀); a load circuit (9) which comprises a lamp choke (Li) and a blocking capacitor (7) and is coupled on one side to the half-bridge center point and on the other side to at least one terminal for connecting the high-pressure discharge lamp (5); a drive circuit (8) for providing at least one first (G1) and one second (G2) drive signal for the first (Q1) and the second electronic switch (Q2), wherein the first and second drive signal (G1, G2) are pulse-width-modulated signals having the same frequency, wherein the pulse duty factor of the two drive signals and the phase angles of the two drive signals relative to each other can be set independently of each other in each case, and the two drive signals can each be inverted in a low-frequency cycle.

### TECHNICAL FIELD

The invention relates to a circuit arrangement and method for operating a high-pressure discharge lamp having a straightened arc, the circuit arrangement comprising at least one first and one second electronic switch in a first half-bridge, a supply voltage connection and a reference ground connection for supplying the half-bridge arrangement with a direct voltage signal, a load circuit which has a lamp choke and a blocking capacitor and is coupled on one side to the half-bridge center point and on the other side to at least one terminal for connecting the high-pressure discharge lamp, and a drive circuit for providing at least one first and one second drive signal for the first and the second electronic switch.

### PRIOR ART

The invention relates to a circuit arrangement and method for operating gas discharge lamps according to the generic portion of the main claim. The invention relates in particular to a circuit arrangement for arc-straightened operation of gas discharge lamps.

For operating high-pressure discharge lamps, in particular standard HCI lamps, but also for operating mercury-free, molecular-radiation-dominated MF lamps, usually a relatively low-frequency square-wave lamp power supply with fast commutation is used. The current commutation serves to prevent one-sided electrode wear and must be effected with sufficiently rapid polarity reversal so that the lamp does not go out during commutation. The commutation time should typically be in the <100 μs range. The commutation frequency is generally selected such that on the one hand the brief discontinuities during the commutation process do not manifest themselves in the light as flickering, which means that the commutation frequency should preferably be >50 Hz, and on the other hand the acoustic emissions both from the electronic operating device and from the hot gas discharge lamp preferably do not fall into the audible frequency range, i.e. the commutation frequency should preferably be <200 Hz. The best results are obtained if the commutation frequency is synchronized at 100 Hz to the supply network and as a result the low-frequency and easily visible mix modes between the possible ripple of the power supply and the fluctuations during the commutation transitions are suppressed. The commutation frequency should, however, also not be set above the audible frequency range at >20 kHz so that during operation of the lamp the natural acoustic resonances of the discharge arc, which of course range between 20 kHz and 150 kHz in the case of conventional lamp geometries, are not arbitrarily excited. Resonant excitation of the arc would in most cases result in arc fluctuation and arc instabilities which may ultimately lead to the extinguishing of the lamp or even to destruction of the lamp.

As a rule most standardized high-pressure discharge lamps can be operated using the above-described simple square-wave mode of operation without this leading to significant arc instabilities and arc deflections. However, special lamp geometries with high aspect ratios are a different matter, i.e. lamps having a high ratio between lamp vessel length and lamp vessel diameter, or arc length to arc diameter, or also in the case of lamps with special lamp gas fills.

In these cases, apart from the possibility of exciting stability-reducing natural acoustic resonances, it is also possible that depending on its orientation, such as vertical or horizontal burning position, the arc is systematically deflected upward from its axial center as a result of upward forces in the hot lamp itself and consequently forms itself into an arc shape between the electrodes. Due to the change in effective arc length, said arc-shaped deflections generally also lead to a change in the electrical plasma operating parameters, such as, for example, the lamp voltage or the position of the natural acoustic resonances, which on the other hand, however, are extremely important for the stable operation of the arc with an electronic operating device (ballast). A systematic arc deflection of this kind can therefore likewise lead to problems with the electrical operation of the lamp and to inherent arc instability.

Furthermore the disadvantages of a deflecting arc are self-evident when one considers the practical application of the lamp in a light and the associated goniometric light outcoupling efficiencies in a reflector system.

In order to avoid these arc deflections in the lamp that usually are induced by upward forces and for the general stabilization of discharge arcs having a high aspect ratio, arc straightening operating methods can now be applied.

In the case of arc straightening the electrical operating device selectively excites a special natural acoustic resonance in the discharge arc of the lamp which due to its modal properties does not lead to the generally typical fluctuations or arc instabilities but rather to increased stability of the arc, in particular in its axial direction. The natural resonances in question here are usually those with an azimuthal mode structure. Reference is made to the excitation of the 2nd azimuthal acoustic mode for the purpose of arc straightening.

The position of the natural azimuthal frequencies active for arc straightening depends not only on the geometry of the lamp (length, aspect ratio) but also on the general operating parameters of the lamp, such as pressure, temperature, fill gas, output etc. In the case of present lamps the azimuthal eigenmodes range between 20 kHz to 150 kHz, typically being at 60 kHz.

The simplest method for targeted excitation of a special natural acoustic frequency in the lamp is to drive the arc already with a high-frequency supply voltage or supply current by means of the electronic operating device.

In contrast to square-wave operation, reference is made here to high-frequency operation or to direct drive. If, for example, it is desired to excite an azimuthal mode in the lamp at 60 kHz in a targeted manner in direct drive mode by means of the electronic operating device, then the electronic operating device must drive the lamp sinusoidally at exactly half the operation mode changeover frequency at 30 kHz. The amplitude spectrum of said supply voltage or said supply current would have a singular frequency component at 30 kHz, while the associated power spectrum, in other words the spectrum of the product of power and voltage, next to the general power line at zero, at precisely double the frequency, in other words, at 60 kHz, will have a singular frequency line with which the corresponding acoustic mode will then be excited in the lamp.

Usually for targeted dosage of the excitation the excitation frequency in the electronic operating device is lightly swept or wobbled, typically +−5 kHz, so that the actual frequency position of the desired mode is met in any case. The sweep repetition rate in this case is usually approx. 100 Hz and if required can also be synchronized to the power supply. The advantage with this method is that the so-called direct drives can be realized with simple circuit arrangements such as, for example, a half-bridge and as a result the electronic operating device can be constructed with lower electronic overhead. The disadvantage with the direct drive method is that it is relatively difficult to control the excitation strength of the desired acoustic eigenmode, since in the case of direct operation the through-modulation factor is always 100% and the two degrees of freedom, the size of the sweep range or the repetition frequency of the sweep can only be taken advantage of to a partial extent.

The size of the sweep range cannot be widened arbitrarily because usually there are additional natural acoustic frequencies in the immediate vicinity of the targeted and arc-straightening active line which preferably should not be reached since upon excitation these would then disadvantageously manifest themselves with their negative effect on arc stability.

As a rule the sweep repetition rate or the sweep repetition frequency also cannot be reduced arbitrarily since unavoidable power fluctuations during the sweep operation can only be exactly compensated by feedback control measures with substantial overhead and said power fluctuations would be noticeable as fluctuation in the light in particular at frequencies <50 Hz.

An alternative method for targeted and suitably dosed excitation of a special natural acoustic frequency of the discharge arc by means of the operating device can, in comparison, be achieved with square-wave operation. In this context this is referred to as square-wave amplitude modulation. In low-frequency square-wave operation the corresponding frequency component must be additively superimposed as amplitude modulation onto the square-wave lamp supply in order to effect the electrical excitation of a special lamp natural frequency.

With this modulation method the modulated frequency component is covered in absolute terms by the value of the actual natural frequency in the lamp and the modulated frequency component appears directly in the power spectrum of the square-wave signal. In this case there is no doubling of frequency as in the case of the direct drive method.

If, for example, the actual natural frequency in the lamp is 60 kHz, the modulated frequency component must also be 60 kHz. So that the line is met in all cases, usually a small sweep range is likewise provided so that variations in lamp geometry or variations in fill properties are covered.

With regard to the desired excitation strength, the choice of modulation depth provides a clear parameter with which the excitation strength can be changed at will and independently of other conditions so that the targeted excitation leads to the desired effect of arc straightening without further negative side-effects. However, a disadvantage of amplitude modulation in square-wave operation is generally speaking its technically complex and time-consuming realization in the electronic operating device, for which reason it has scarcely been implemented generally in electronic operating devices to date.

In the prior art there are various publications relating to this alternative method, although these are all rather formal in character in that the circumstances surrounding amplitude modulation for the purpose of arc straightening are described, and the technical implementation is illustrated only on the basis of schematic circuit layouts which can hardly be realized as an economical and marketable solution.

In U.S. Pat. No. 6,147,461, for example, a method is described as a technical solution wherein the supply voltage of a full-bridge circuit, which usually serves as an outcoupling stage for square-wave operation of a high-pressure discharge lamp, is driven by means of a modulated direct-current voltage supply, the modulation occurring as an overlay on the square-wave signal of the lamp supply.

In order to generate the amplitude-modulated direct-current supply voltage, a separate modulation stage in the form of a standard step-down converter is used which is driven at the envisaged modulation frequency. The smoothing characteristic is tuned with the smoothing condenser such that the operating frequency of the step-downstage is not filtered out completely and as a result remains as a residue at the desired depth on the direct current level of the supply voltage.

FIG. 8 shows the schematic circuit layout of the circuit arrangement 11 according to the prior art. The circuit arrangement 11 consists of a DC-DC converter 110, an alternating-current voltage generation unit 120 and a full-bridge arrangement 130. In this embodiment the circuit shown initially has at least 2 chokes and 5 switches. If the building of a power factor correction circuit and the building of an ignition unit are also taken into account here, then an electronic operating device with this topology would require at least 3 chokes and 7 or 8 switches, resulting in high costs. The modulation depth is predetermined here by the circuit configuration and no longer permits infinite adjustment via software control during operation.

Conventional electronic operating devices without amplitude modulation can usually be implemented with fewer than 6 switches. The supply voltage modulation method for a circuit arrangement with a full-bridge proposed according to the prior art can also be applied to other circuit topologies which are used to generate a square-wave supply voltage for a high-pressure discharge lamp.

According to the prior art there are other concepts for generating an unmodulated square-wave voltage apart from the full-bridge approach. One of these is based upon the technology of a half-bridge circuit with blocking capacitors of adequate size. With this concept, which is illustrated in FIG. 9, the two switches Q₁, Q₂ of the half-bridge are operated complementarily in synchronism with the desired low-frequency square-wave voltage, the opposite blocking capacitors C_{B} being selected in terms of their capacitance such that they are able to completely absorb the current through the lamp during the long forward phase and then release it again through the lamp during the following backward phase. The charge and discharge time of the blocking capacitors C_{B} amounts in this case to 2*5 ms, which corresponds to a frequency of 100 Hz. The circuit arrangement comprising a half-bridge 131 and large blocking capacitors C_{B} is, for the purpose of imposing an amplitude modulation, also equipped with an alternating-current voltage generation unit 120, this modulation then having an additive effect upon the square-wave current going to the lamp. The illustrated circuit consists initially of 2 chokes and 3 switches. If the building of a power factor correction unit and the building of an ignition unit are also taken into account, an electronic operating device with this topology would have at least 3 chokes and 5 to 6 switches. The modulation depth is usually determined by the circuit configuration and in this case too can no longer be continuously adjusted during operation by way of software control. Conventional operating devices in this half-bridge topology without amplitude modulation can usually be realized with fewer than 4 switches.

### OBJECT

It is an object of the invention to disclose a circuit arrangement for operating a high-pressure discharge lamp with a straightened arc, having at least one first (Q₁) and one second electronic switch (Q₂) in a half-bridge arrangement, a supply voltage connection and reference ground connection for supplying the half-bridge arrangement with a direct voltage signal (U₀), a load circuit (9) which comprises a lamp choke (L₁) and a blocking capacitor (7) and is coupled on one side to the center point of the half-bridge and on the other to at least one terminal for connecting the high-pressure discharge lamp (5), and a drive circuit (8) for providing at least one first and one second drive signal for the first (Q₁) and the second electronic switch (Q₂), in which circuit arrangement the modulation depth is continuously adjustable during operation and which is economical to manufacture.

It is also an object of the invention to disclose a method for operating a high-pressure discharge lamp which can be performed with the circuit arrangement and by means of which the modulation depth can be continuously adjusted during operation.

### DESCRIPTION OF THE INVENTION

The objective with regard to the circuit arrangement is achieved according to the invention by means of a circuit arrangement for operating a high-pressure discharge lamp with a straightened arc, comprising at least one first and one second electronic switch in a first half-bridge, a supply voltage connection and a reference ground connection for supplying the half-bridge arrangement with a direct voltage signal, a load circuit which has a lamp choke and a blocking capacitor and is coupled on one side to the center point of the half-bridge and on the other side to at least one terminal for connecting the high-pressure discharge lamp; a drive circuit for proving at least one first and one second drive signal for the first and the second electronic switch, wherein the first and second drive signals are pulse-width-modulated signals of the same frequency, and the pulse widths of the two drive signals and the phase angles of the two drive signals relative to each other can be set independently of each other in each case and the two drive signals are each inverted in a low-frequency cycle. Because both switches are driven by means of high-frequency pulse-width-modulated signals which are inverted at low frequency and are individually adjustable in the phase angle to each other and in the pulse width modulation, a freely adjustable amplitude modulation of the generated operating square-wave signal can be produced for the high-pressure discharge lamp.

In the load circuit of the circuit arrangement according to the invention a blocking capacitance from a blocking capacitor connected in series with the discharge lamp is employed to advantage in this case. The circuit arrangement according to the invention functions particularly well if the load circuit utilizes a blocking capacitance provided by two blocking capacitors which in relation to the discharge lamp are symmetrically connected to the supply voltage terminals. In this way the voltage applied to the high-pressure discharge lamp is particularly well symmetrized.

If the circuit arrangement has a second half-bridge with a third and a fourth electronic switch which excites a resonance circuit for ignition of the gas discharge lamp, an advantageous resonance ignition can be employed for the high-pressure discharge lamp. The second half-bridge is in this case advantageously arranged between the center point of the first half-bridge and the circuit ground. In this case the third and the fourth electronic switch of the second half-bridge are preferably also controlled by the drive circuit.

The object with regard to the method is achieved according to the invention by means of a method for operating a high-pressure discharge lamp with a circuit arrangement as described above, wherein, during the operation of the gas discharge lamp, the following steps are performed:
driving the first and second electronic switch with a first and second drive signal, wherein the drive signals are pulse-width-modulated signals of the same frequency,
setting the pulse duty factors of the drive signals,
setting the phase angle of the two drive signals relative to each other,
inverting the two drive signals in a low-frequency cycle.

With this method a low-frequency square-wave voltage is applied to the high-pressure discharge lamp which has high-frequency amplitude modulation which can be simply and continuously adjusted by means of the method. Preferably it should be possible in each case to set the pulse duty factor of the drive signal for the first electronic switch and for the second electronic switch separately and independently of each other. In a preferred embodiment based thereon, the pulse duty factor or the phase angle continues to be varied during operation. This may be necessary, for example, in order to respond to changed boundary conditions, such as e.g. the input voltage.

For ignition of the high-pressure discharge lamp the following steps are preferably performed. For this purpose the circuit arrangement must have a second half-bridge with a third and a fourth electronic switch as well as a resonance circuit:
closing the first electronic switch and opening the second electronic switch,
driving the second half-bridge in such a way that the resonance circuit is excited and a voltage is generated which, when applied to the gas discharge lamp, leads to ignition of the gas discharge lamp (5),
turning on the third electronic switch and turning off the fourth electronic switch, as well as operating the first half-bridge according to the above-described method.

An advantageous resonance ignition of the high-pressure discharge lamp is performed by means of this method.

If the following steps are performed, the high-pressure discharge lamp is not only started by means of resonance ignition, but at the same time also operated immediately with an advantageous ramp-up curve. For this purpose the circuit arrangement must have a second half-bridge with a third and a fourth electronic switch as well as a resonance circuit:
closing the first electronic switch and opening the second electronic switch,
driving the second half-bridge in such a way that the resonance circuit is excited and a voltage is generated which, when applied to the gas discharge lamp, leads to ignition of the gas discharge lamp,
driving the second half-bridge at a predetermined frequency in such a way that that a predetermined power flows into the gas discharge lamp,
turning on the third electronic switch and turning off the fourth electronic switch, as well as operating the first half-bridge according to the above-described method.

These two ignition methods just described are executed for starting the high-pressure discharge lamp before the actual lamp operation according to the invention is performed.

Further advantageous developments and embodiments of the circuit arrangement according to the invention and of the method according to the invention for operating a high-pressure discharge lamp will become apparent from further dependent claims and from the following description.

### BRIEF DESCRIPTION OF THE DRAWING(S)

Further advantages, features and details of the invention will emerge from the following description of exemplary embodiments and with reference to the accompanying drawings, in which identical or functionally identical elements are provided with identical reference characters. In the drawings:

FIG. 1 shows a circuit arrangement according to the invention for generating an amplitude-modulated alternating-current signal for operation of a gas discharge lamp in a first embodiment variant with a half-bridge arrangement having one blocking capacitor,

FIGS. 2a-e show some drive signals during the forward mode of operation (upper transistor conducting) at low amplitude modulation,

FIGS. 3a-e show some drive signals during the forward mode of operation (upper transistor conducting) at high amplitude modulation,

FIGS. 4a-e show some drive signals during the backward mode of operation (lower transistor conducting) at low amplitude modulation,

FIGS. 5a-e show some drive signals during the backward mode of operation (lower transistor conducting) at high amplitude modulation,

FIG. 6 shows a circuit arrangement according to the invention for generating an amplitude-modulated alternating-current signal for operation of a gas discharge lamp in a second embodiment variant with a half-bridge arrangement 5 having two symmetrically arranged blocking capacitors,

FIG. 7 shows a circuit arrangement according to the invention for generating an amplitude-modulated alternating-current signal for operation of a gas discharge lamp in a third embodiment variant with a half-bridge arrangement having two symmetrically arranged blocking capacitors and a resonance ignition device,

FIG. 8 shows a circuit arrangement according to the prior art for generating an amplitude-modulated alternating-current signal for operation of a gas discharge lamp in a full-bridge arrangement,

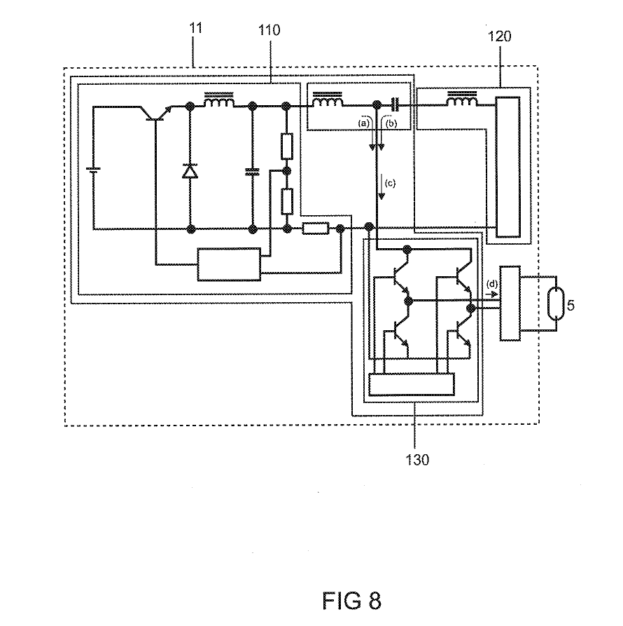

FIG. 9 shows a circuit arrangement according to the prior art for generating an amplitude-modulated alternating-current signal for operation of a gas discharge lamp in a half-bridge arrangement.

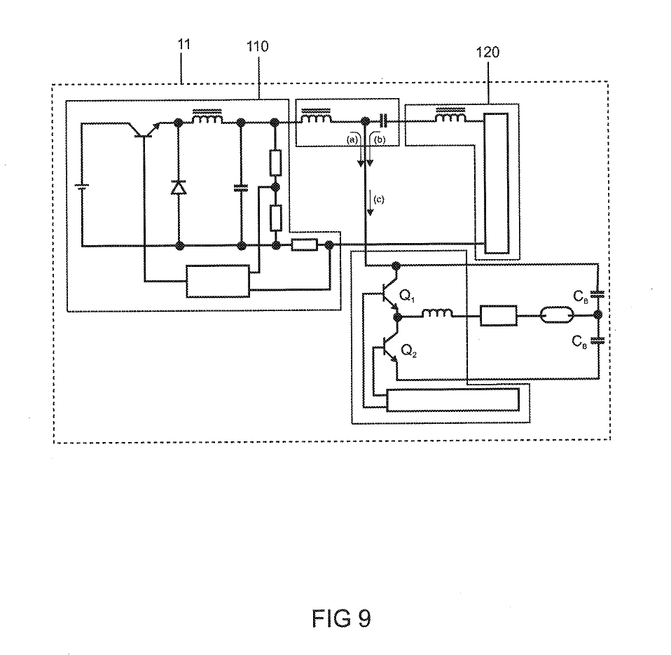

### PREFERRED EMBODIMENT OF THE INVENTION

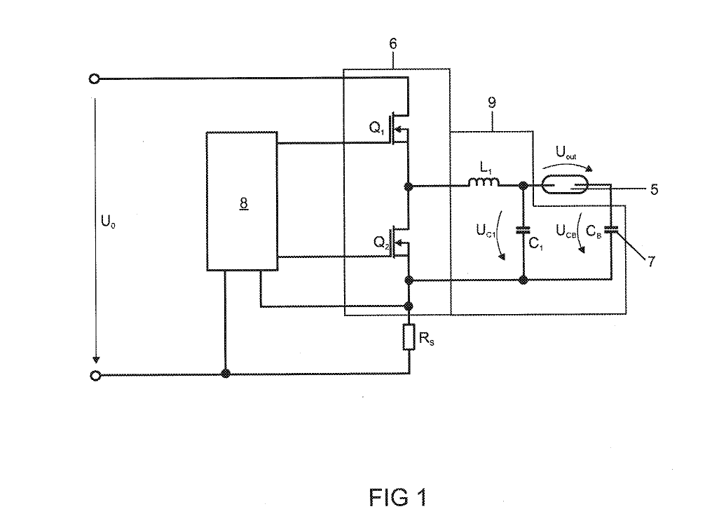

FIG. 1 shows a circuit arrangement according to the invention for generating an amplitude-modulated alternating-current signal for operation of a gas discharge lamp in a first embodiment variant with a half-bridge arrangement having one blocking capacitor. This circuit arrangement embodies a concept wherein a square-wave power supply for a lamp can be generated on which an amplitude modulation can be additively superimposed, and wherein the amplitude modulation depth can be continuously adjusted by software control means. The square-wave signal has a very low frequency (approx. 50-150 Hz), while the modulated signal has a high frequency which is adjustable in the range around 60 kHz. The basic concept of the circuit arrangement gets by with two MOS-FETs (field-effect transistors), which, when considering an overall concept for an electronic operating device with power factor correction circuit and ignition circuit, would increase to fewer than five MOS-FETs. The circuit arrangement according to the invention has a half-bridge arrangement 6 which comprises two MOS-FETs and to which a load circuit 7 for supplying a gas discharge lamp 5 is connected. The load circuit 7 has a lamp choke L₁, a capacitor C₁ and a blocking capacitor C_{B}. The half-bridge arrangement 6 is fed by a supply voltage which is supplied via a supply voltage connection and a reference ground connection for supplying the half-bridge arrangement 6 with a direct-current voltage signal U₀. A microcontroller 8 is used to control the circuit arrangement and generates a first and a second drive signal for the first MOS-FET Q₁ and the second MOS-FET Q₂. A current-sensing resistor Rₛ is connected in series with the half-bridge 6, the microcontroller 8 tapping the voltage via the current-sensing resistor Rₛ.

At the gas discharge lamp 5 the circuit arrangement according to FIG. 1 generates a low-frequency square-wave voltage with an amplitude modulation depth that is adjustable via the programming of the microcontroller 8. The circuit arrangement is based on the half-bridge inverter principle with a large blocking capacitor C_{B}. The size or capacitance of the blocking capacitor must be chosen such that the direct-current voltage level becoming set at it remains largely constant during the entire long square-wave cycle (approx. 5 ms). In the steady state the direct-current voltage level at the blocking capacitor lies at around U_{CB}=½*U₀. In this case, however, the amplitude modulation is not effected by a separate modulation stage as in the prior art cited in the introduction, but by both MOS-FETs Q₁, Q₂ being in each case driven during the respective half-cycles in such a way that the desired current or voltage level is established at the lamp and at the same time the lamp current is modulated to the desired depth. In this case the amplitude modulation depth can also be set by driving both half-bridge MOS-FETs. The switching sequences required for driving the gates are generated by software means in a microcontroller and from there are supplied to the gates via commercially available gate driver stages. The individual steps for implementing this method are described below:

Initially, the half-bridge is supplied with a constant intermediate circuit voltage U₀. The intermediate circuit voltage U₀ is provided by a power factor correction circuit (not shown) and typically amounts to U₀=400 VDC to 500 VDC. Next, the two square-wave low-frequency current cycles are produced via the respective circuitry of the two MOS-FETs. Here, forward and backward phases of the low-frequency signal last, as already mentioned above, approx. 5 msec in each case. In the forward cycle the upper MOS-FET Q₁ is driven like a step-down converter, with the switching frequency f_{mod}=1/T_{mod}=1/T being kept constant. The constant operating frequency of the MOS-FET Q₁ corresponds to the envisaged modulation frequency. The selected operating frequency may also, of course, be easily varied or swept, e.g. by ±5 kHz, without any restriction in accordance with the swept amplitude modulation frequency.

The turn-on time t₁ of the upper MOS-FET Q₁, i.e. the pulse duration tₒₙ of the first drive signal, is initially chosen such that the step-down condition v=Uₒᵤₜ/U₀=tₒₙ/T is present, i.e. tₒₙ<=(Uₒᵤₜ/U₀)*T. A modulation frequency of f_{mod}=60 kHz would result in a period duration of T=16 μs and a desired step-down of the output voltage Uₒᵤₜ from U₀=450V to Uₒᵤₜ=340V would result in a pulse duration of tₒₙ=12.6 μs. The maximum current Iₘₐₓ becoming set in the choke L₁ during this turn-on time is calculated from (U₀−Uₒᵤₜ)=L₁*Iₘₐₓ/tₒₙ or Iₘₐₓ=(1/L₁)*(U₀−Uₒᵤₜ)*tₒₙ, where U₀=450V and Uₒᵤₜ=340V and (U₀−Uₒᵤₜ)=(450V-340V)=110V, and where L₁=0.5 mH, Iₘₐₓ amounts to 2.77 A.

At the end of this brief turn-on phase the general current free-running phase commences in the step-down choke. The duration t_{frei} of the free-running phase is dependent on the instantaneous output voltage Uₒᵤₜ and on the value of the inductance L₁. It holds that Uₒᵤₜ=L₁*Iₘₐₓ/t_{frei} or t_{frei}=L₁*Iₘₐₓ/Uₒᵤₜ. Using the above values the result is a free-running time of t_{frei}=4.0 μs. As a result the step-down choke would, given these conditions, be free-running after 4.0 μs and the start of the next opening time could thus be immediately re-introduced. In this state the half-bridge can operate at constant operating frequency according to the principle of a conventional step-down converter, the lamp closed to the blocking capacitor C_{B} acting as load. Because of the large, yet limited capacitance of the blocking capacitor C_{B}, after a certain period of time, in this case 5 ms, a commutation, that is to say the reversal of the current direction, must be introduced, which is of course also desirable for technical reasons connected with the lamp.

The commutation is easily effected in that the drive sequences currently used for the forward cycle are exchanged in mirror-image fashion at the two gates, with the half-bridge now functioning as a step-up converter starting from circuit ground instead of a step-down converter starting from U₀. For example, in the forward cycle the voltage was stepped down by 110V starting from U₀ to 340V, then in the backward cycle it is stepped up by 110V starting from circuit ground to 110V. The amplitude modulation at the output of the half-bridge may in this case be varied in the following manner:

Initially, the size of the smoothing capacitor C₁ at the output is chosen such that with a basic specification of the switching time values a mean target value for amplitude modulation is set and the level of amplitude modulation can then be varied around this. If the lower MOS-FET Q₂ now continues to be held active in the conducting state beyond the natural free-running time (e.g. 4.0 μs+xμs), then the smoothing capacitor C₁ is discharged in reverse to a slight extent via the choke and the lower MOS-FET, which as a result has the effect of an increased modulation fluctuation on the smoothing capacitor C₁.

The duration of the conducting state of the lower MOS-FET Q₂ beyond the natural free-running time thus determines the amplitude modulation depth on the smoothing capacitor C₁ at the output of the choke L₁. The turn-on time of the upper MOS-FET Q₁ must of course be moved back in the same way, such that the turn-on process can continue to take place under switching-load-free conditions. Any reduction of power which this readjustment entails must be compensated by readjustment of the input voltage, in this case the intermediate circuit voltage U₀, with the aid of a power factor correction circuit disposed upstream of the circuit arrangement according to the invention. If, after 5 ms, it is desired to introduce the reverse current direction with the commutation, then, as already stated, the circuitry just described must be applied in precise mirror-image fashion to the two MOS-FETs Q₁ and Q₂, that is to say, the drive signal must be inverted. The resulting signal development is an exact mirror image of the forward phase.

Through alternating operation of the half-bridge both as step-down converter and step-up converter, the half-bridge can, in combination with a large blocking capacitor C_{B}, be used as a square-wave generator. The commutation of the current direction through the operational changeover from step-down converter to step-up converter is effected by mirroring or inversion of the signal sequences at the gates of the MOS-FETs Q₁ and Q₂. By means of the balanced switching sequences the half-bridge can be driven at a constant operating frequency. By suitable choice of the smoothing capacitor C₁ a specific amplitude modulation can be imposed in advance on the generated square-wave supply signal. The amplitude modulation frequency can be set by the choice of the operating frequency for the half-bridge. The variation in the amplitude modulation depth can be continuously adjusted via the tₒₙ/t_{off} ratio by software means. The slow power changes at the lamp which are attendant on said variations in amplitude modulation can be stabilized through power regulation of the output voltage U₀ of the power factor correction circuit.

If the amplitude modulation is not wanted during the operating phase or startup phase of the gas discharge lamp 5 and is to be turned off completely, then the operating frequency of the half-bridge 6 may optionally be set by the microcontroller 8 at a higher value, e.g. 120 kHz, at which the smoothing capacitor C₁ fully smoothes out the fluctuations in amplitude.

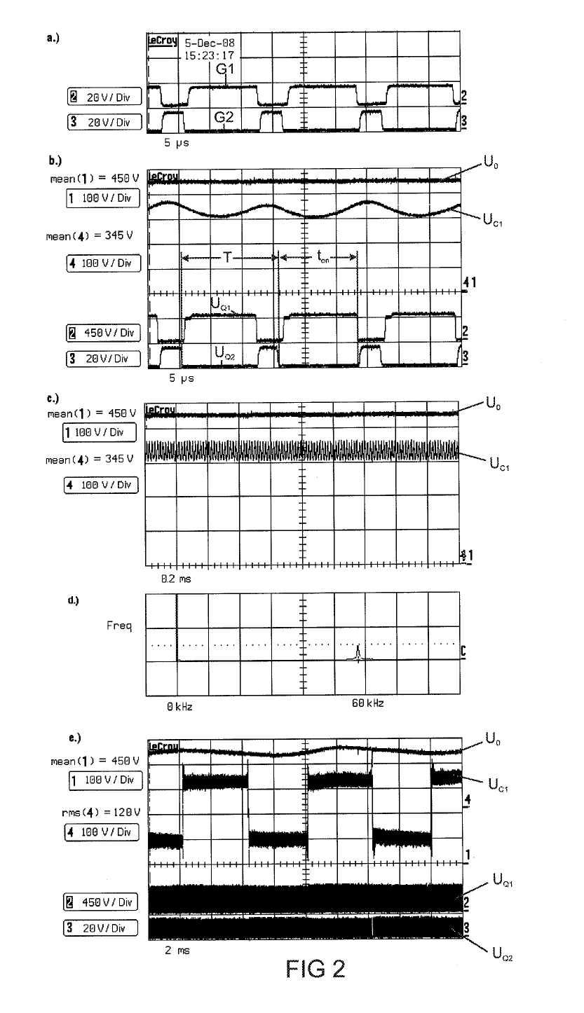

FIGS. 2a to 2d illustrate the scheme for driving the MOS-FETs Q₁, Q₂ in the forward mode of operation (upper transistor Q₁ conducting) at low amplitude modulation and its effects on operation. The gate signals U_{Q1}, U_{Q2} are shown together with the corresponding waveform of the control signals G1 and G2 and the corresponding development of the analog supply signals U₀, U_{C1}.

Overall it is shown how amplitude modulation can be realized and how, through variation of the complementary turn-on and turn-off times of the two MOS-FETs Q₁, Q₂ within the predefined period duration T, the amplitude modulation depth can be adjusted to the square-wave signal.

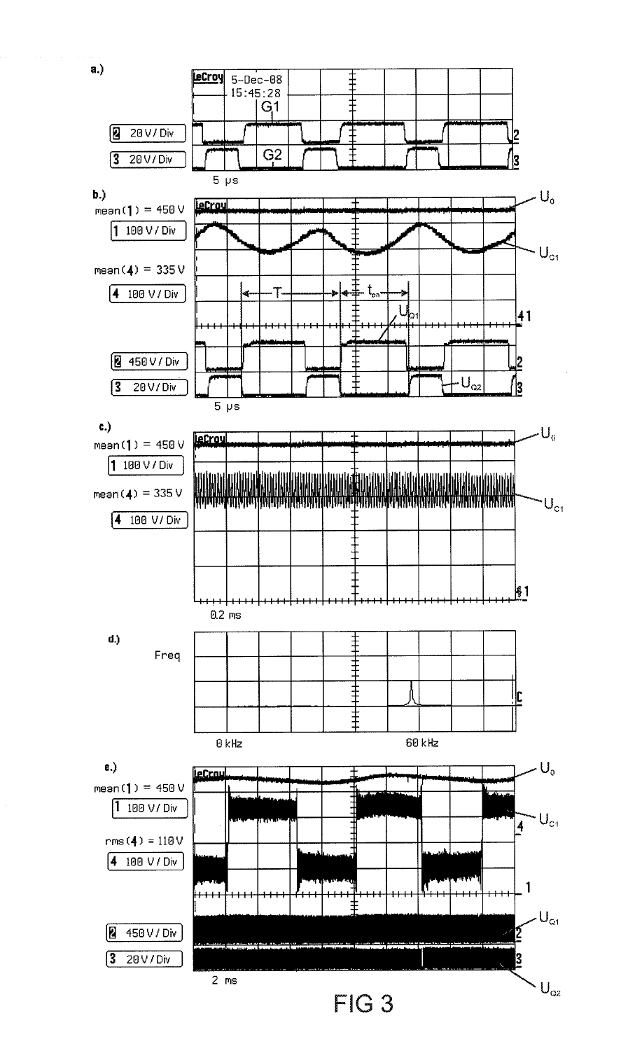

FIGS. 2a-d and FIGS. 3a-d show the situation in forward operation, when the current flows via the lamp to the blocking capacitor. The period duration amounts to T=16 μs≡60 kHz.

FIG. 2 in this case shows the forward operation at low amplitude modulation. The turn-on time of the upper MOS-FET is long and the turn-on time of the lower MOS-FET is short. During the short turn-on time of the lower MOS-FET the discharge of the smoothing capacitor C₁ is only small, as a result of which the fluctuation at the capacitor, and hence the degree of amplitude modulation, is likewise only small.

FIG. 3 shows the forward operation at higher amplitude modulation. The turn-on time of the upper MOS-FET Q₁ is shorter and the turn-on time of the lower MOS-FET Q₂ is longer. During the longer turn-on time of the lower MOS-FET Q₂ the discharge of the smoothing capacitor C₁ is higher, as a result of which the fluctuation at the capacitor, and hence the degree of amplitude modulation, is high.

FIG. 2a and FIG. 3a show the gate signals G1, G2 as they were directly generated in the microcontroller. The turn-on/turn-off times during the predefined operating or modulation frequency can be varied by software means. In FIG. 2a the turn-off time of the upper signal G1 is shorter and the residual modulation will be smaller. In FIG. 3a the turn-off time is longer and the residual modulation will be greater.

FIG. 2b and FIG. 3b show how the half-bridge is supplied by a constant intermediate circuit voltage of U₀=450V, and how as a result the circuitry is formed at the half-bridge MOS-FETs Q₁ and Q₂, and how the stepped-down voltage develops on the smoothing capacitor C with its remaining fluctuations. The residual modulation is smaller in FIG. 2b and greater in FIG. 3b. The drive signals U_{Q1} and U_{Q2} generated from the gate signals G1, G2 are shown in the lower section. The signal U_{Q2} corresponds to the signal G2, while the signal U_{Q1} is the signal generated from the signal G1 by the driver.

FIG. 2d and FIG. 3d show the Fourier spectrum of said stepped-down voltage which as a result of the amplitude modulation now also has a line at f=60 kHz in addition to the general power line at zero. The modulation line is lower in FIG. 2c and higher in FIG. 3c.

FIGS. 2c, e and FIGS. 3c, e show the supply and power signals in shorter time resolutions, such that the interaction between the low-frequency square-wave voltage and the high-frequency modulation frequency can be studied. In particular, the voltage at the smoothing capacitor U_{C1} shows very clearly the low-frequency square-wave voltage which is modulated by the high-frequency square-wave voltage. In FIG. 2e the degree of modulation is low, whereas in FIG. 3e it is high.

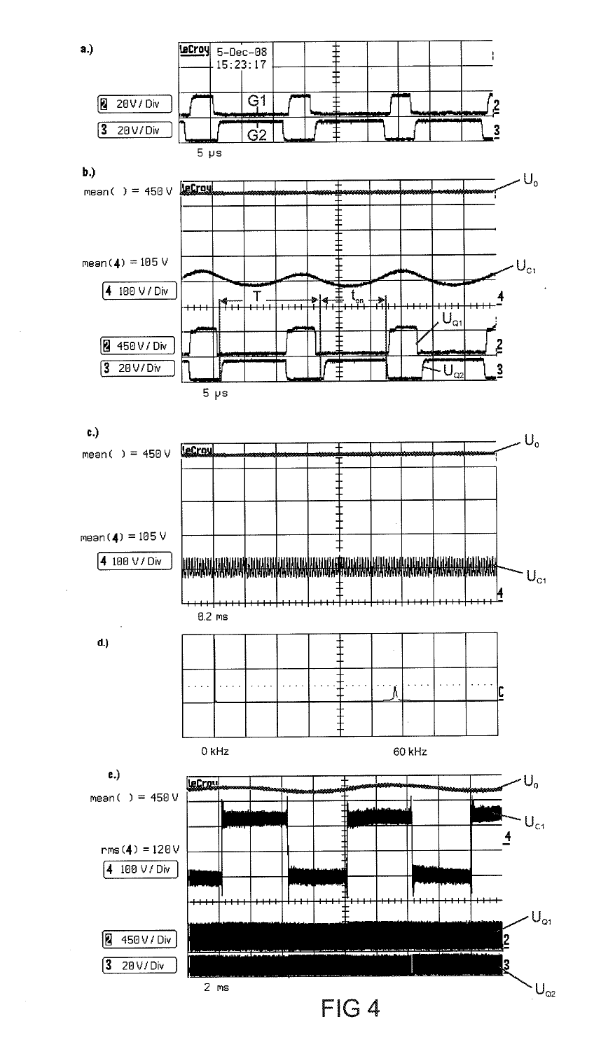

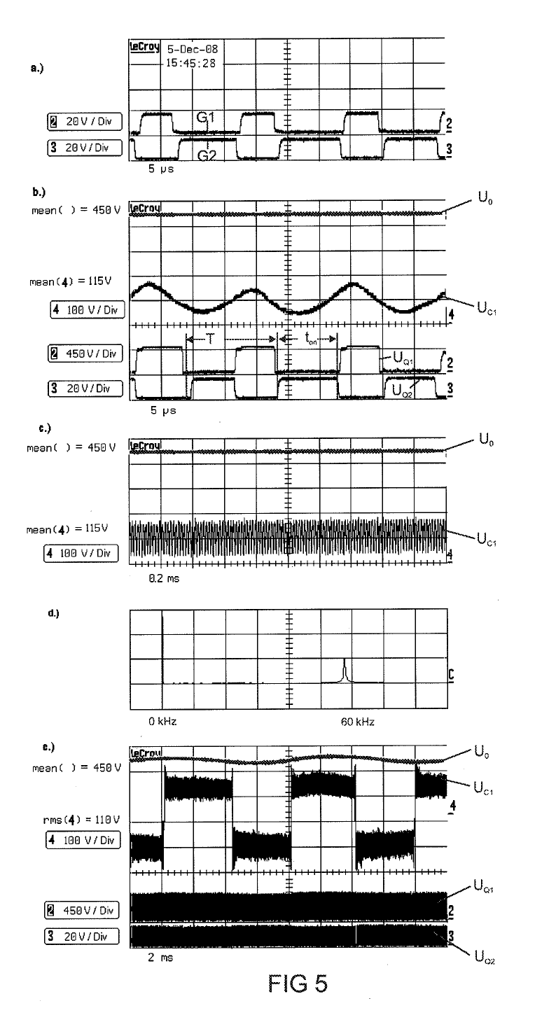

FIG. 4 and FIG. 5 illustrate the situation in the backward mode of operation, when the current is flowing via the lamp from the blocking capacitor C_{B}. FIG. 4 and FIG. 5 are mirror-symmetrical with respect to FIG. 2 and FIG. 3. In other words the pulse schemes transposed in mirror-image fashion in FIG. 2 and FIG. 3 are shown, and how the corresponding analog supply signals develop. While in the forward mode case, as shown in FIG. 2 and FIG. 3, the stepped-down voltage at the smoothing capacitor was stepped down by approx. 110V starting from U₀=450V, in the backward mode case, as shown in FIG. 4 and FIG. 5, the voltages at the smoothing capacitor are stepped up by approx. 110V starting from Gnd=0V. The difference in output voltages between the forward phase and the backward phase is supplied at the end of the lamp as square-wave operating voltage, which in this case is additionally provided with amplitude modulation. It can readily be seen that the drive signals G1, G2, U_{Q1}, U_{Q2} are inverted with respect to the forward mode of operation.

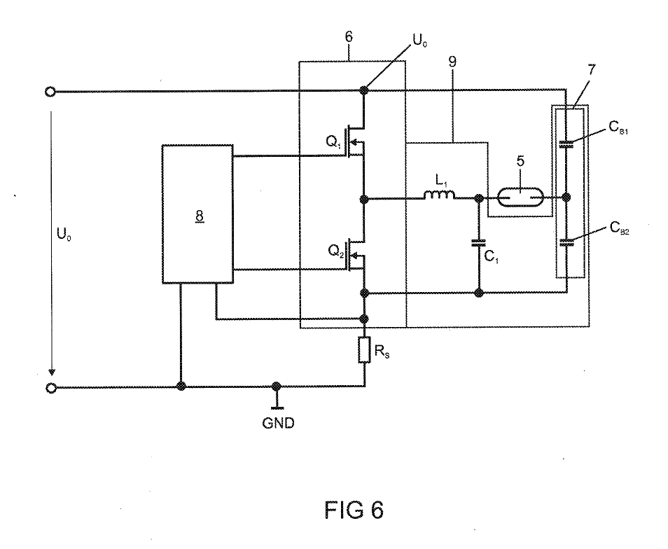

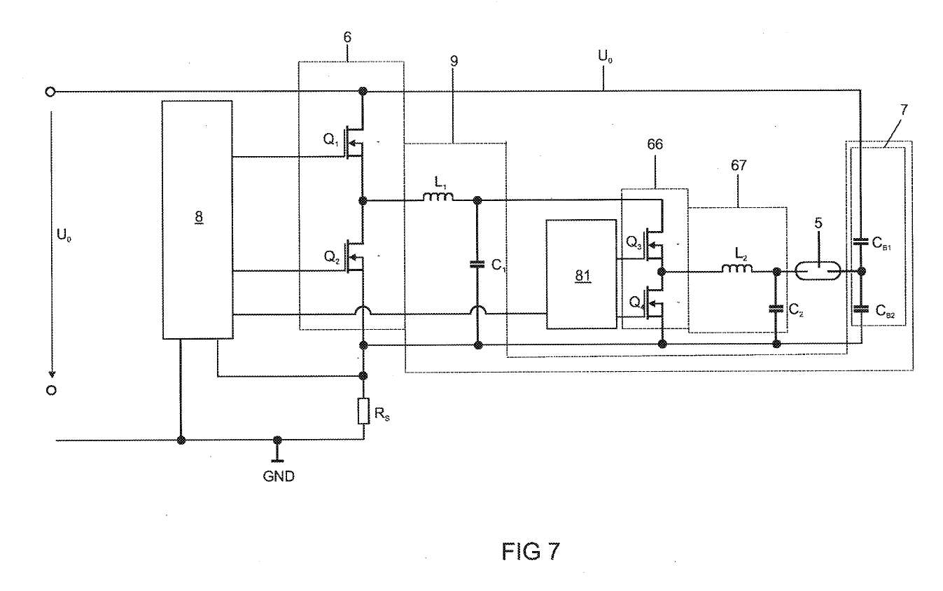

FIGS. 6 and 7 show two further embodiment variants of the circuit arrangement according to the invention: FIG. 6 essentially reflects the circuit topology of FIG. 1, with the difference that here a blocking capacitance 7 is employed comprising two blocking capacitors C_{B1}, C_{B2}, which are essentially connected symmetrically to U₀ and Gnd. This type of blocking capacitor coupling exhibits a better response during the transition to the steady state, since after turn-on the stationary blocking voltage U_{CB}=½*U₀ builds up more quickly between the two blocking capacitors C_{B1}, C_{B2}. Moreover, in this arrangement the intermediate circuit voltage U₀ can still be blocked or buffered simultaneously by means of the two blocking capacitors C_{B1}, C_{B2}.

FIG. 7 illustrates a third embodiment variant of the circuit arrangement according to the invention. Here, in addition to the half-bridge 6 for operating the gas discharge lamp 5, a further half-bridge 66 has been introduced, consisting of Q₃, Q₄ for ignition of the gas discharge lamp 5 by means of resonance ignition. Before the lamp is started, the resonance ignition voltage for ignition of the lamp can be generated as standard by startup of the further half-bridge 66 at the resonance frequency. For this purpose the half-bridge 6 may be set permanently in forward operation to a constant output voltage, with which the ignition half-bridge 66 is then supplied. The additionally introduced ignition resonance circuit 67, consisting of an ignition choke L₂ and a resonance capacitor C₂, is also well suited for operation of the lamp during the starting phase or lamp startup, in which case the requisite current consumption can easily be set by the choice of the operating frequency for the ignition half-bridge 66. The changeover to square-wave operating mode is not introduced until the lamp, during its startup phase, is almost within its nominal range, shortly before the natural acoustic resonances of the lamp become active. After the changeover to square-wave operation the ignition module must of course be switched to inactive, which can be realized by the upper MOS-FET Q₃ in the ignition circuit being permanently set to turned-on, while the lower MOS-FET Q₄ in the ignition circuit remains permanently turned off. In the nominal square-wave phase the ignition choke L₂ is then only present as a passive choke in the lamp circuit.

1. A circuit arrangement for operating a high-pressure discharge lamp having a straightened arc, comprising:
at least one first and one second electronic switch in a first half-bridge;
a supply voltage connection and a reference ground connection for supplying the half-bridge arrangement with a direct voltage signal;
a load circuit which comprises a lamp choke and a blocking capacitor and is coupled on one side to the half-bridge center point and on the other side to at least one terminal for connecting the high-pressure discharge lamp;
a drive circuit for providing at least one first and one second drive signal for the first and the second electronic switch,
wherein the first and second drive signal are pulse-width-modulated signals having the same frequency, wherein the pulse duty factor of the two drive signals and the phase angles of the two drive signals relative to each other can be set independently of each other in each case, and the two drive signals can each be inverted in a low-frequency cycle.

2. The circuit arrangement as claimed in claim 1, wherein the load circuit has a blocking capacitance consisting of one blocking capacitor which is connected in series with the at least one terminal of the high-pressure discharge lamp.

3. The circuit arrangement as claimed in claim 1, wherein the load circuit has a blocking capacitance consisting of two block capacitors which are each connected symmetrically from at least one terminal of the high-pressure discharge lamp to the supply voltage connection and the reference ground connection in each case.

4. The circuit arrangement as claimed in claim 1, wherein the circuit arrangement has a second half-bridge which has a third and a fourth electronic switch for driving a resonance circuit for igniting the gas discharge lamp and is arranged between the center point of the first half-bridge and a circuit ground.

5. The circuit arrangement as claimed in claim 4, wherein the third and the fourth electronic switch of the second half-bridge can likewise be driven by the drive signal.

6. A method for operating a high-pressure discharge lamp having a circuit arrangement as claimed in claim 1 the following steps being performed during the operation of the gas discharge lamp:
driving the first and second electronic switch with a first and second drive signal, the drive signals being pulse-width-modulated signals having the same frequency;
varying or setting the pulse duty factors of the drive signals;
setting the phase angle of the two drive signals relative to each other,
inverting the two drive signals in a low-frequency cycle.

7. The method as claimed in claim 6, wherein the phase angle of the two drive signals relative to each other is varied during operation.

8. The method as claimed in claim 6, wherein the pulse duty factors of the drive signal for in each case the first electronic switch and the second electronic switch are set separately and independently of each other.

9. (canceled)

10. (canceled)
